(19) United States
(12) Patent Application Publication
(10) Pub. No.: US 2019/0034910 A1
(43) Pub. Date: Jan. 31, 2019

(54) TRANSACTION PROCESS FOR SMART CHIP CARD TRANSACTIONS

(71) Applicant: Value Payment Systems, LLC, Nashville, TN (US)

(72) Inventors: Jeffrey GARDNER, Nashville, TN (US); Jeffrey Scott Slusser, Columbia, TN (US)

(73) Assignee: Value Payment Systems, LLC, Nashville, TN (US)

(21) Appl. No.: 15/660,323

(22) Filed: Jul. 26, 2017

(51) Int. Cl. G06Q 20/34; G06Q 20/40; G06Q 20/38

(52) U.S. Cl. CPC G06Q 20/341; G06Q 20/382; G06Q 20/401

(57) ABSTRACT

Systems and methods for processing financial transactions using smart chip technology are disclosed. The present invention provides for payments to be made to multiple payees with a single transaction performed via a single insertion or dip of a smart chip card into a smart chip terminal or a single tap of the smart chip card within a predetermined proximity of a smart chip terminal. Specific applications include transactions which include principal payment amounts paid to a first party with convenience fees and/or surcharges paid to a second party for the principal transaction.

### BACKGROUND OF THE INVENTION

### 1. Field of the Invention

The present invention relates to electronically processing financial transactions which include payments to multiple payees, and more specifically to systems and methods for processing an EMV (Europay MasterCard VISA) or smart chip transaction which includes payments to multiple payees.

### 2. Description of the Prior Art

It is generally known in the prior art to provide processing for financial transactions.

Prior art patent documents include the following:

US Publication No. 20150193757 for System and method for allocating charges away from a tax account by inventor Luongo et al., filed Jan. 6, 2014 and published Jul. 9, 2015, is directed to a transaction processing system suitable for processing a merchant transaction includes a computer having a processor, a memory, a plurality of connections over a network for receiving and settling the merchant transaction; and a separator module operative to separate funds associated with the merchant transaction. The separator module further includes a revenue settlement module operative to settle a revenue portion of the merchant transaction in favor of a first account accessible over the network, the first account being associated with the merchant; a tax settlement module operative to settle the tax portion associated with the merchant transaction in favor of a second account accessible over the network, the second account being different than the first account; and a fee resolution module operative to resolve fees associated with operation of the tax settlement module, such that an amount equal to the tax portion is settled in favor of the second account.

U.S. Pat. No. 8,560,448 for System and method to initiate funding of multiple merchant accounts by inventor Nonni et. al, filed Dec. 30, 2008 and issued Oct. 15, 2013, is directed to a system to initiate funding of a plurality of merchant accounts may include one or more computers configured to receive input specifying at least one payment item having a payment amount, determine a convenience fee based on the at least one payment amount, select a first merchant account based on the at least one specified payment item, and select a second merchant account associated with the convenience fee. The one or more computers may also be configured to receive a single input specifying credit card information, link the payment amount, received credit card information and the first merchant account to form a first transaction, and link the convenience fee, received credit card information and second merchant account to form a second transaction. The one or more computers may further be configured to submit the first and second transactions to a credit card authorization network, receive response data from the credit card authorization network for the first and second transactions indicating whether the first and second transactions are authorized, and generate output representing a receipt for the first and second transactions if the first and second transactions are authorized.

US Publication No. 20140372320 for Systems and methods for emv chip and pin payments by inventor Goldfarb et. al., filed May 2, 2014 and published Dec. 18, 2014, is directed to in transactions between a consumer and a merchant (or other third party) using services of a payment provider (e.g., credit card company, or financial services provider), methods and systems are provided for enabling any third party to accept chip and PIN payment and payment provider services using a payment provider device that is enabled using the third party's own application (referred to herein as “app”) and not the app of the payment provider. Enabling a merchant to accept chip and PIN payments usually requires the merchant to certify (accredit) their application (e.g., a point-of-sale (POS) system) end to end with the payment providers (e.g., Visa, MasterCard). A software development kit (SDK) modification to the application allows the merchant to accept chip and PIN cards the without the need to certify the application. The SDK includes the functionality that needs to be certified, and certifies it once with a service provider.

US Publication No 20150006407 for Systems, methods, and computer program products providing payment in cooperation with emv card readers by inventor Lunn et. al., filed Jan. 11, 2013 and published Jan. 1, 2015, is directed to an electronic payment system provided by a mobile communication device, the system including a memory storing instructions for interacting with a EMV card reader to cause payment from an issuing bank associated with a cardholder to an acquiring bank of a merchant associated with the electronic payment processing system; and one or more processors in communication with the memory configured to: initiate a transaction by passing transaction information, including a transaction amount, to the EMV card reader; receive encrypted payment authorization from the EMV card reader to process a payment from the issuing bank to the acquiring bank, wherein the one or more processors are in communication with the EMV card reader; pass the encrypted payment authorization to the acquiring bank over a data connection; and receive a confirmation of payment from the acquiring bank over the data connection.

Contactless Specifications for Payment Systems Books A, B, C-1, C-2, C-3, C-4, C-5, C-6, and C-7 Version 2.6 by EMVCo, LLC, published April 2016, August 2016, and May 2016, respectively, discuss EMV Architecture and General Requirements, Entry Point, and Specifications for Kernels 1-7. The Contactless Payment Systems Books A, B, C-1, C-2, C-3, C-4, C-5, C-6, and C-7 Version 2.6 are hereby incorporated herein by reference in their entirety.

Quick Chip for EMV Specification Version 1.2 by VISA Public, published August 2016, is directed to modifications to the use of standard processes for contact chip transactions that is compatible with EMV kernels and optimizes processing time by removing or reducing dependencies for chip insertion time in the reader. Quick Chip for EMV Specification Version 1.2 by VISA Public is hereby incorporated herein by reference in its entirety.

Amex Quick Chip Technical Manual Version 1.1 by American Express AEIPS, published August 2016, is directed to enabling Card Members to dip their card at any time during the checkout process and remove it before the transaction is completed—significantly improving Card Members' perception of payment transaction speed and streamlining the checkout experience, while providing the security benefits of an EMV chip card transaction. Amex Quick Chip Technical Manual Version 1.1 is hereby incorporated herein by reference in its entirety.

### SUMMARY OF THE INVENTION

The present invention relates to systems and methods of processing smart chip transactions. More specifically, the present invention relates to systems and methods of processing smart chip transactions which have previously required multiple separate “dips” or insertions and removals of the smart chip card for contact EMV transactions, or multiple separate “taps” or placings of the smart chip card within a predetermined proximity of the smart chip card reader for contactless EMV transactions, by using only one “dip” or “tap” of the smart chip card for multiple payments. Specifically, the present invention provides for multiple payments to be originated and subsequently processed with a single dip or tap. These multiple payments are then settled to different accounts.

It is an object of this invention to provide faster processing for EMV or smart chip transactions which involve payments to multiple parties. Faster processing for these transactions results in financial benefits for the operator of the terminal by allowing the operator to process transactions more quickly, thus saving the operator time per transaction. This also allows more transactions to be processed at the terminal, which results in more payments over a time period. The present invention also provides a streamlined payment process for the payor by the payor only inserting the smart chip card once for the transaction or only placing the smart chip card within a predetermined proximity of the terminal once, thus saving time in the payor making multiple payments. These advantages will aid in the acceleration of adoption of EMV payments with merchants, providing a reduced risk of fraudulent transactions for merchants, processors, and payment processing gateways. Merchants have also been slow in adopting EMV technology to accept payments because of the complexities surrounding EMV transactions. However, with the fraud liability shift in 2015 to US merchants who do not use EMV transactions for accepting payments, the advantages and ease of adoption provided by the present invention will cause more merchants to adopt EMV technology for payments, thus shifting the liability for any fraudulent transactions performed via EMV away from the merchants. Enabling more payees to shift to accepting EMV payments represents a huge financial benefit for the merchants.

Throughout this application, smart chip and EMV are used to refer to cards which include integrated circuits and are inserted (“dipped”) into a reader or placed within a predetermined proximity of the reader (“waved” or “tapped”) to process a transaction. Additionally, the payment processing gateway is in an exemplary embodiment Value Payment Systems, sometimes abbreviated as VPS throughout this application and the drawings.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a “shopping cart” method for processing an EMV transaction for one or more items according to one embodiment of the present invention.

FIG. 2 illustrates a method for processing an EMV transaction for one item according to one embodiment of the present invention.

FIG. 3 illustrates an electronic cash register (ECR) method for processing an EMV transaction according to one embodiment of the present invention.

FIG. 4 illustrates a method for processing an EMV transaction for one item according to one embodiment of the present invention.

FIG. 5 illustrates a method for processing an EMV transaction for multiple items according to one embodiment of the present invention.

FIG. 6 illustrates a method for processing an EMV transaction which includes payments to multiple payees with only one insertion or tap.

FIGS. 7A & 7B illustrate a method for processing an EMV transaction which includes two separate payments to two different entities with a single dip or tap of a smart chip card. Specifically, FIG. 7A illustrates the steps of the method from the start of the method through the terminal requesting the authorization request cryptogram (ARQC). FIG. 7B illustrates the completion of the method initiated in FIG. 7A.

FIG. 8 is a schematic diagram of an embodiment of the invention illustrating a computer system.

### DETAILED DESCRIPTION

The present invention is generally directed to systems and methods for processing smart chip or EMV transactions. EMV transactions are also referred to as smart card transactions, Integrated Circuit Card (ICC) transactions, or chip transactions.

The 2015 U.S. Fraud Liability Shift to merchants who do not use chip-enabled devices and applications to process payment transactions has caused many merchants to utilize these chip-enabled devices and applications. Instead of traditional Point of Sale (POS) transaction methods such as magnetic stripe transactions, payors are increasingly using smart chip or EMV technology at POS terminals. Some transactions made at a payment terminal include multiple payments to multiple entities for a payment or purchase. By way of example, payments to governments and utilities often require a primary payment to be paid to one entity and a convenience fee, service fee, or surcharge to be paid to a different entity. Currently, for contact EMV or smart chip transactions, payors must insert their smart chip card into the smart chip terminal for the first payment, wait for the first payment to be processed, remove their smart chip card from the terminal, insert their smart chip card into the smart chip terminal for the second payment, wait for the second payment to be processed, and finally remove their smart chip card from the terminal to perform these transactions. For contactless EMV or smart chip transactions, payors must place their smart chip card within a predetermined proximity of the smart chip terminal for the first payment, wait for the first payment to be processed, remove their smart chip card from within the predetermined proximity of the smart chip terminal, place their smart chip card within a predetermined proximity of the terminal for the second payment, and wait for the second payment to be processed before finally removing their smart chip card from within the predetermined proximity of the terminal. This transaction process is time consuming and is a burden for both the payor and the operator of the terminal processing the payment. There is an unmet need for an improved transaction process which provides for processing multiple payments to multiple parties using a smart chip or EMV card that only requires the payor in the transaction to dip or insert the smart chip or EMV card into the smart chip terminal once for contact EMV transactions, or to tap or place the smart chip or EMV card within the predetermined proximity to the smart chip terminal once for contactless EMV transactions.

None of the prior art discloses the described systems and methods for processing payments to multiple different payees, including merchants, payment processing gateways, and other recipients of funds in transactions via a smart chip card which only require the payor to insert the smart chip card into the payment terminal once for contact EMV transactions, or which would only require the payor to place the smart chip card within a predetermined proximity of the terminal once for contactless EMV transactions. Furthermore, no more than one authorization from the payor for the entire transaction amount comprising the multiple payments to multiple different payees, which is presented as line items and a total or just as a total, is required under the methods and systems of the present invention.

Multiple payments to multiple payees are processed according to the type of smart chip card which is inserted into the terminal or placed within the predetermined proximity of the terminal. Two types of smart chip processes commonly utilized in transactions are the traditional smart chip approach and the “quick chip” smart chip approach. The traditional smart chip approach authorizes a transaction while the smart chip card is still inserted into a slot of a payment card reader. In contrast, the quick chip approach authorizes the transaction after the smart chip card has been removed from the slot of the payment card reader. The quick chip approach shortens the amount of time that the smart chip card is required to be in the reader during the transaction. Currently, VISA, American Express, and MasterCard offer quick chip functionality. Quick Chip for EMV Specification Version 1.2 by VISA Public, published August 2016 and Amex Quick Chip Technical Manual Version 1.1 by American Express AEIPS, published August 2016 are incorporated herein by reference in their entirety.

Notably, the methods and systems of the present invention apply to contact or contactless traditional smart chip transactions and contact and contactless quick chip smart chip transactions.

Generally, the present invention includes the following steps. The smart chip card is inserted into a smart chip terminal or placed within a predetermined proximity of the smart chip terminal to begin processing the transaction. The smart chip terminal reads the smart chip of the smart card and performs the steps typically involved in beginning to process an EMV transaction. Notably, the smart chip terminal also determines the card number associated with the credit card. Preferably, the card number associated with the credit card is extracted using the Tag 57 Track 2 Equivalent Data that is retrieved for the application kernel after the card is inserted into the smart chip terminal or placed within a predetermined proximity of the smart chip terminal. Tag 57 in one embodiment contains the data elements of track 2 according to ISO/IEC 7813, including start sentinel (1 character), end sentinel (1 character), Longitudinal Redundancy Check (1 character), Primary Account Number (up to 29 characters) Field Separator (1 character, Hex ‘D’) (b) Expiration Date (YYMM) (4 digits) Service Code (3 digits), and Discretionary Data (variable amount of characters determined by card issuer—this includes card code and/or PINs in some embodiments).

The smart chip terminal then sends the EMV data which is typically sent in EMV transactions and the card number, which is not sent in prior art EMV transactions, to the payment processing gateway, which is connected to the terminal over a network. A payment processing gateway includes one or more computers connected over a network and is operable to calculate, determine, and/or present a convenience fee, service fee, or surcharge associated with a transaction based on the issuer of the smart chip card used in the transaction and/or a variety of other factors. The payment processing gateway calculates and presents a convenience fee or surcharge associated with the transaction, and communicates the convenience fee or surcharge to the terminal. The terminal then presents the total transaction cost, preferably as itemized line items or alternatively as one amount. Upon receiving an acceptance of the total transaction cost, the terminal sends a payment packet along with smart chip data to the payment processing network, either directly or through the payment processing gateway, to process a first payment associated with the transaction as a non-smart chip transaction. The term payment processing network as used throughout this specification refers to at least one computer connected over a network to the terminal and at least one issuer, an intermediary, and/or a payment processor computer. If the convenience fee or surcharge is approved, the payment processor also processes the second payment as a smart chip transaction. Approval for the payments from the financial institution is transmitted from the intermediary over the network to the terminal, and the account associated with the card is updated.

Alternatively, the first payment is the principal amount and the second payment is the convenience fee or surcharge, with the first payment being processed as an EMV transaction and the second payment processed as a non-EMV transaction. In another embodiment, the first payment and the second payment are both processed as EMV transactions upon a single dip or tap of the smart chip card. Notably, these alternatives apply both to conventional EMV transactions and the “quick chip” transactions described below.

In one embodiment, the present invention includes a method for processing multiple payments in a single smart chip transaction at a smart chip terminal initiated by inserting a smart chip card into the smart chip terminal or placing the smart chip card within a predetermined proximity of the terminal. The smart chip terminal then sends the EMV data which is typically sent in EMV transactions and the card number, which is not sent in prior art EMV transactions, to the payment processing gateway, which is connected to the terminal over a network. The payment processing gateway calculates and presents a convenience fee or surcharge associated with the transaction, and communicates the convenience fee or surcharge to the terminal. The terminal then presents the total transaction cost, preferably as itemized line items or alternatively as one amount. If not already determined by the terminal, the next steps include the smart chip terminal determining an application ID (AID) of the smart chip card to use for the multiple payments, the smart chip terminal requesting an authorization request cryptogram (ARQC) from the smart chip for a first payment, the smart chip terminal transmitting a first authorization request, including the ARQC to the payment processing gateway, which formats and sends the ARQC to the payment processing network. Alternatively, the ARQC is sent directly to the payment processing network. Upon receiving a positive authorization response from the payment processing gateway or payment processing network for the first authorization request, the smart chip terminal requests a first transaction certificate from the smart chip card to complete processing of the first payment, upon receiving the first transaction certificate, the smart chip terminal issuing a warm reset to the smart chip card, the smart chip terminal requesting the ARQC from the smart chip for a second payment, the smart chip terminal transmitting a second authorization request based on the ARQC to the payment processing gateway or payment processing network, and upon receiving a positive authorization response from the payment processing gateway or payment processing network for the second authorization request, the smart chip terminal requesting a second transaction certificate from the smart chip card to complete processing of the second payment.

The warm reset issued to the smart chip card is preferred for security purposes for terminals where EMV and non-EMV chip cards are both used. However, the warm reset step is omitted in some embodiments of the present invention, with an exemplary embodiment being where the smart chip terminal receives the first transaction certificate and then requests the ARQC for the second payment without issuing a warm reset.

In another embodiment, the present invention includes a method for processing multiple payments in a single smart chip transaction at a smart chip terminal initiated by inserting a smart chip card into the smart chip terminal or by placing the smart chip card within a predetermined proximity of the terminal. The smart chip terminal then sends the EMV data which is typically sent in EMV transactions and the card number or primary account number (PAN), which is not sent in prior art transactions which are initiated or involve EMV or smart chip technology, to the payment processing gateway, which is connected to the terminal over a network. The payment processing gateway calculates and presents a convenience fee or surcharge associated with the transaction, and communicates the convenience fee or surcharge to the terminal. The terminal then presents the total transaction cost, preferably as itemized line items or alternatively as one amount. If not already determined by the terminal, the next steps include the smart chip terminal determining an application on a smart chip of the smart chip card to use for the multiple payments, the smart chip terminal requesting an authorization request cryptogram (ARQC) from the smart chip for a first payment, upon receiving the ARQC, the smart chip terminal requesting an application authorization cryptogram (AAC) from the smart chip, the application indicating to the smart chip terminal that the application is currently unable to go online, the smart chip terminal issuing a warm reset to the smart chip card, the smart chip terminal requesting the ARQC from the smart chip for a second payment, upon receiving the ARQC, the smart chip terminal requesting the AAC and indicating to the smart chip terminal that the application is currently unable to go online, removing the smart chip card from the smart chip terminal for contact EMV transactions, the smart chip terminal transmitting a first authorization request based on the ARQC, upon receiving a positive authorization response from the payment processing gateway or network for the first authorization request, the smart chip terminal sending a second authorization request based on the ARQC to the payment processing gateway or network, and the smart chip terminal receiving a positive authorization response from the payment processing gateway or network for the second authorization request.

The warm reset issued to the smart chip card is preferred for security purposes for terminals where EMV and non-EMV chip cards are both used. However, the warm reset step is omitted in some embodiments of the present invention, with an exemplary embodiment being where the smart chip terminal receives the first transaction certificate and then requests the ARQC for the second payment without issuing a warm reset.

In yet another embodiment, the present invention includes a system for processing multiple payments in a single smart chip transaction including a first payment and a second payment at a smart chip terminal including a smart chip payment card including a smart chip, a smart chip terminal operable to interact with the smart chip payment card, and a payment processing gateway connected to the smart chip terminal for determining a convenience fee associated with processing one or more payments initiated with the smart chip payment card and for communicating with a payment processing network. Alternatively, the payment processing network is in direct network communication with the smart chip terminal. The smart chip terminal is operable to extract EMV or smart chip data from the smart chip card and extract a card number from the card (preferably via the Tag 57 Track 2 Equivalent Data retrieved for the application kernel), send the card number to the payment processing gateway, receive a convenience fee amount associated with the transaction from the payment processing gateway, present the total transaction amount including the convenience fee, send a first authorization request formatted as a non-smart chip transaction authorization request to the payment processing gateway or network for the first payment in the single smart chip transaction, wherein upon receiving an authorization for the first transaction from the gateway or network and upon receiving a first transaction certificate from the smart chip card for the first payment, the smart chip terminal issues a warm reset to the smart chip card, wherein the smart chip terminal is operable to send a second authorization request to the payment processing network or gateway for the second payment in the single smart chip transaction, wherein upon receiving a second transaction certificate from the smart chip card for the second payment, the smart chip terminal is operable to complete processing for the single smart chip transaction. In another embodiment, the terminal is operable to communicate directly with a payment processing network after receiving the convenience fee from the payment processing gateway.

Advantageously, the present invention provides for payment(s) date(s) equal to the date of the authorization(s) of the payment(s) such that a payment authorized on the due date for the payment is on time and no processing delays are incurred.

Communication protocols for the methods and systems of the present invention include those known to one of ordinary skill in the art, including Internet based communication protocols (IP protocols). In an exemplary embodiment, communication is performed via HTTPs POSTs. Other communication protocols include cellular communication (ex: 3G, 4G, LTE, etc.) and landline telephone communication.

Referring now to the drawings in general, the illustrations are for the purpose of describing a preferred embodiment of the invention and are not intended to limit the invention thereto.

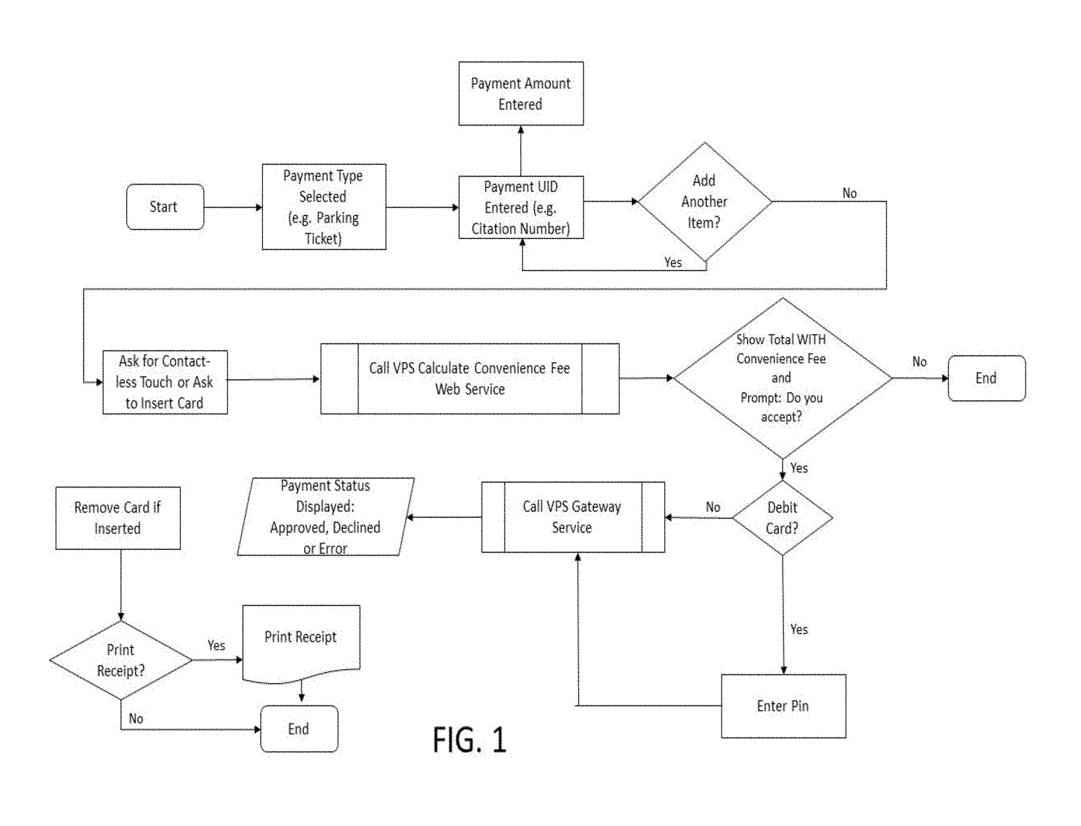

FIG. 1 illustrates a “shopping cart” method for processing an EMV transaction for one or more items according to one embodiment of the present invention. A payment type is selected for the transaction, a payment user ID and/or item identification number is entered (if applicable), a payment amount is entered manually or automatically determined, and any other items are added to the transaction. The terminal prompts for a smart chip card to be inserted or placed within a predetermined proximity of the terminal for a contactless transaction, and a payment processing gateway is contacted to calculate a convenience fee for the transaction. The terminal requests acceptance of the total transaction amount with the convenience fee. If the smart chip card is a debit card, a Personal Identification Number (PIN) is entered. Alternatively, PIN entry is bypassed or not requested by the terminal. The payment processing gateway is called and the payments to the payee and the intermediary or gateway are processed. The terminal communicates the payment status, and the smart chip card is removed and/or a receipt is printed.

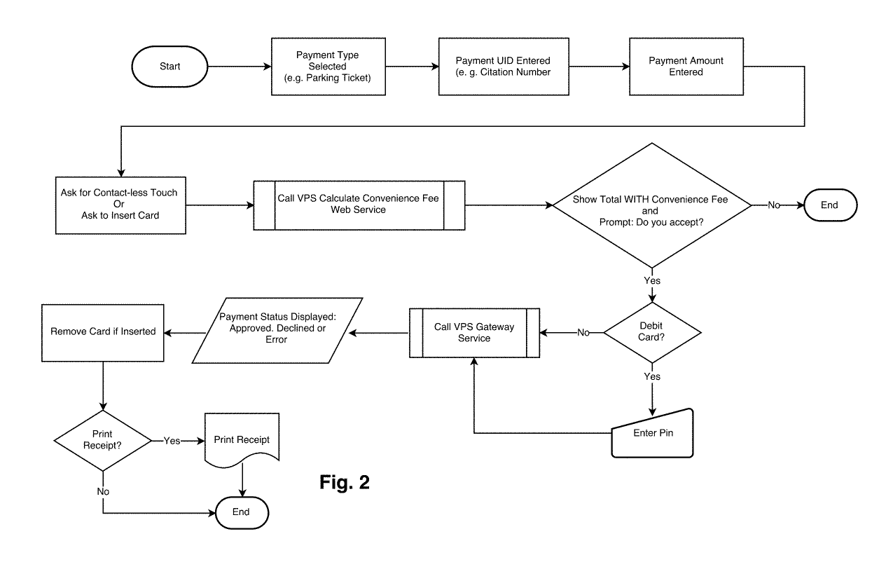

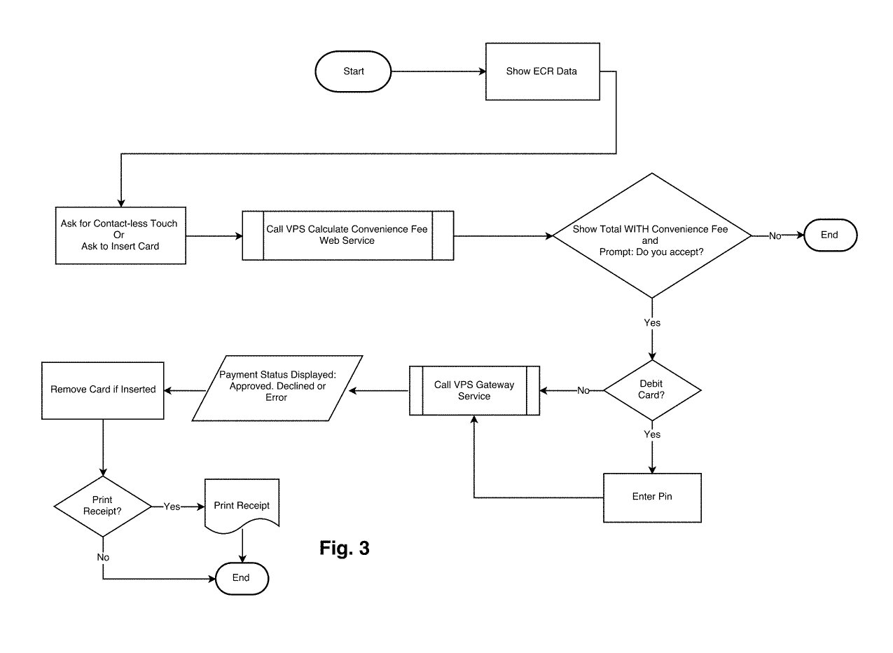

FIG. 2 illustrates a method for processing an EMV transaction for one item according to one embodiment of the present invention. A payment type is selected for the transaction, a payment user ID and/or item identification number is entered (if applicable), and a payment amount is entered manually or automatically determined. The payment type is preferably selected from a variety of payment types, including by way of example and not limitation, parking ticket payments, tax payments, utility payments and/or child support payments. In one embodiment, a citation number, account number, social security number, or other identifying information for the transaction is also entered. Alternatively, no identifying information other than that provided by the smart chip of the card is necessary to process the transaction. The terminal prompts for a smart chip card to be inserted or placed within a predetermined proximity of the terminal for a contactless transaction, and a payment processing gateway is contacted to calculate a convenience fee for the transaction. A prompt is issued for the user to accept the total transaction amount, including the primary payment and the convenience fee. Upon the terminal receiving acceptance of the total transaction amount, the terminal determines whether the inserted smart chip card or contactless smart chip card is a credit card or a debit card. If the smart chip card is a debit card, the terminal issues a prompt for entry of a Personal Identification Number (PIN). Alternatively, the terminal is configured such that the terminal does not prompt for entry of a PIN. This is preferably accomplished by a terminal configuration setting at the terminal level which processes all card transactions as credit transactions. This is a configuration per terminal download. In yet another embodiment, the present invention provides for a PIN bypass mechanism with WP which enables an operator of the terminal to bypass the PIN entry. In this embodiment, the terminal recognizes the transaction as a debit card transaction but provides an option for the operator of the terminal to bypass the PIN number entry. In another embodiment, the terminal prompts for the form of debit (ex: signature debit or PIN debit), and is operable to bypass the PIN debit via one of the methods described above. Upon receiving a PIN or bypassing the PIN entry for the smart chip debit card, the payment processing gateway is called to connect to the payment processing network. If the transaction is being made using a smart chip credit card, no PIN entry is requested or required and the gateway service of the payment processing network is called. Preferably, the payment processing gateway is contacted via a web service. In one embodiment, the convenience fees are calculated in accordance with the systems and methods described in U.S. Pub. No. 2014/0279524, published Sep. 18, 2014, and U.S. Pub. No 2017/0004481, published Jan. 5, 2017, each of which is incorporated herein by reference in its entirety. The payment processing network sends an authorization request to an issuer computer associated with the issuer of the card and receives an authorization code from the issuer if credit is available. Upon receiving the authorization code, the payment processing gateway authorizes the transaction. If the payment is authorized, then the terminal indicates that the payment was approved, preferably via a Graphical User Interface (GUI) display. Alternatively, the terminal indicates, preferably via a GUI display, that the payment was declined or there was an error code. The terminal prompts for the smart chip card to be removed from the terminal if the smart chip card is a contact smart chip card. Additionally, the terminal displays a prompt asking if the consumer wants a receipt. A receipt is printed if the user responds affirmatively to the prompt for the receipt. Upon printing the receipt or upon the user indicating they do not want a receipt, which in one embodiment occurs upon passage of a certain amount of time after the prompt for the user to remove the smart chip card if the smart chip card is a contact smart chip card, the transaction is ended.

FIG. 3 illustrates an electronic cash register (ECR) method for processing an EMV transaction according to one embodiment of the present invention. ECR data is displayed on the terminal and the terminal prompts for a smart chip card to be inserted or placed within a predetermined proximity of the terminal for a contactless transaction, and a payment processing gateway is contacted to calculate a convenience fee for the transaction. The terminal requests acceptance of the total transaction amount with the convenience fee. If the smart chip card is a debit card, a Personal Identification Number (PIN) is entered. Alternatively, PIN entry is bypassed or not requested by the terminal. The payment processing gateway is called and the payments to the payee and the intermediary or gateway are processed. The terminal communicates the payment status, and the smart chip card is removed and/or a receipt is printed.

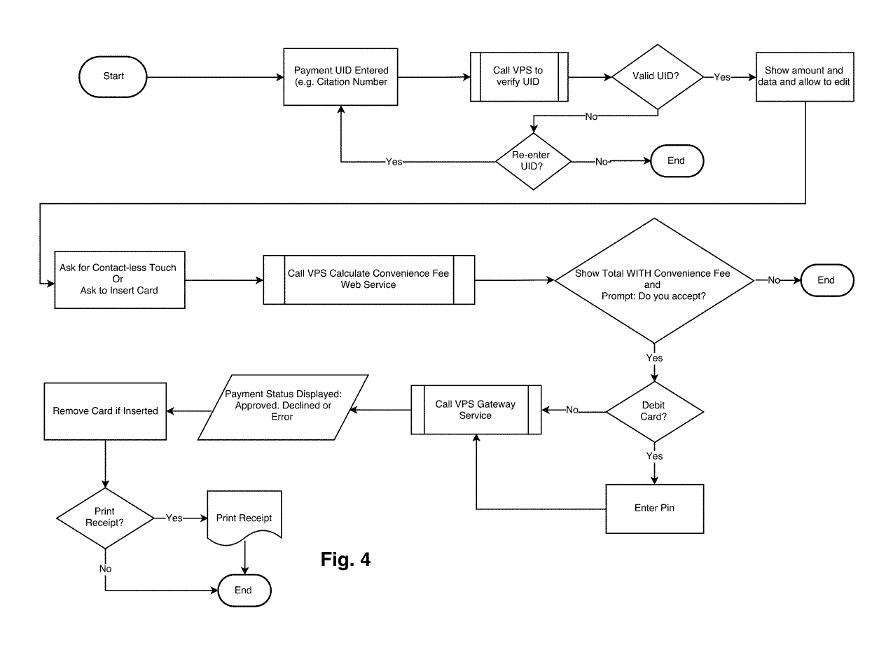

FIG. 4 illustrates a method for processing an EMV transaction for one item according to one embodiment of the present invention. A user ID and/or item identification number is entered. A payment processing gateway is contacted to verify the user ID and/or item identification number. If the user ID and/or item identification number is deemed not valid by the payment processing gateway, the terminal prompts for reentry of the user ID and/or item identification number. Upon determining that the user ID and/or item identification number is valid, an amount for the transaction and other data relevant to the transaction is displayed. The amount for the transaction and other data relevant to the transaction is editable. Upon finalization of the amount for the transaction and the other data, the terminal prompts for a smart chip card to be inserted or placed within a predetermined proximity of the terminal for a contactless transaction, and a payment processing gateway is contacted to calculate a convenience fee for the transaction. The terminal requests acceptance of the total transaction amount with the convenience fee. If the smart chip card is a debit card, a Personal Identification Number (PIN) is entered. Alternatively, PIN entry is bypassed or not requested by the terminal. The payment processing gateway is called and the payments to the payee and the intermediary or gateway are processed. The terminal communicates the payment status, and the smart chip card is removed and/or a receipt is printed.

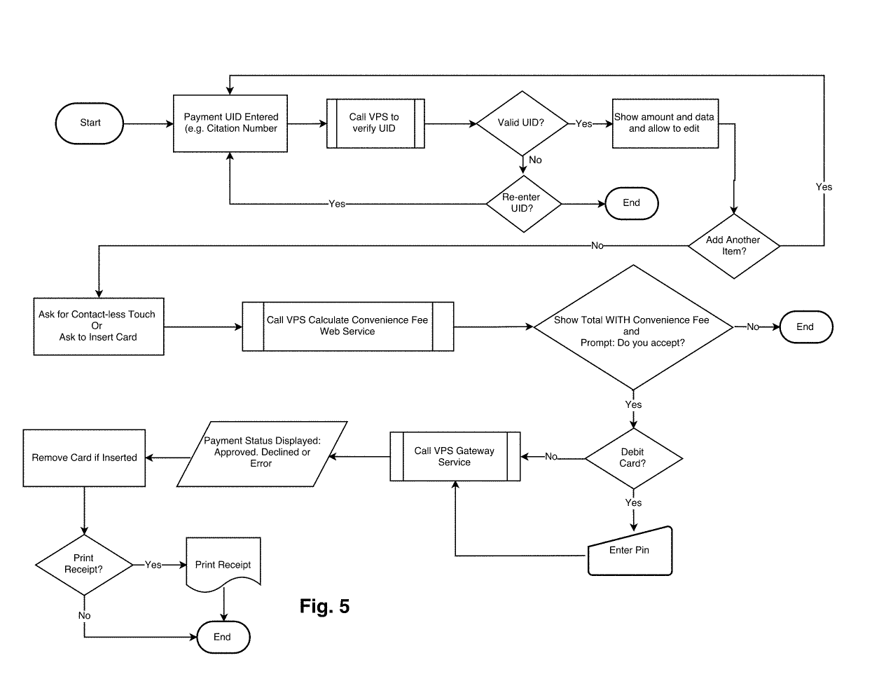

FIG. 5 illustrates a method for processing an EMV transaction for multiple items according to one embodiment of the present invention. A user ID and/or item identification number is entered. A payment processing gateway is contacted to verify the user ID and/or item identification number. If the user ID and/or item identification number is deemed not valid by the payment processing gateway, the terminal prompts for reentry of the user ID and/or item identification number. Upon determining that the user ID and/or item identification number is valid, an amount for the transaction and other data relevant to the transaction is displayed. The amount for the transaction and other data relevant to the transaction is editable. Upon editing the amount for the transaction and other data relevant to the transaction, the terminal prompts for the addition of another item, which is added according to the previously recited steps. Upon finalization of the items, the amount for the transaction, and the other data, the terminal prompts for a smart chip card to be inserted or placed within a predetermined proximity of the terminal for a contactless transaction, and a payment processing gateway is contacted to calculate a convenience fee for the transaction. The terminal requests acceptance of the total transaction amount with the convenience fee. If the smart chip card is a debit card, a Personal Identification Number (PIN) is entered. Alternatively, PIN entry is bypassed or not requested by the terminal. The payment processing gateway is called and the payments to the payee and the intermediary or gateway are processed. The terminal communicates the payment status, and the smart chip card is removed and/or a receipt is printed.

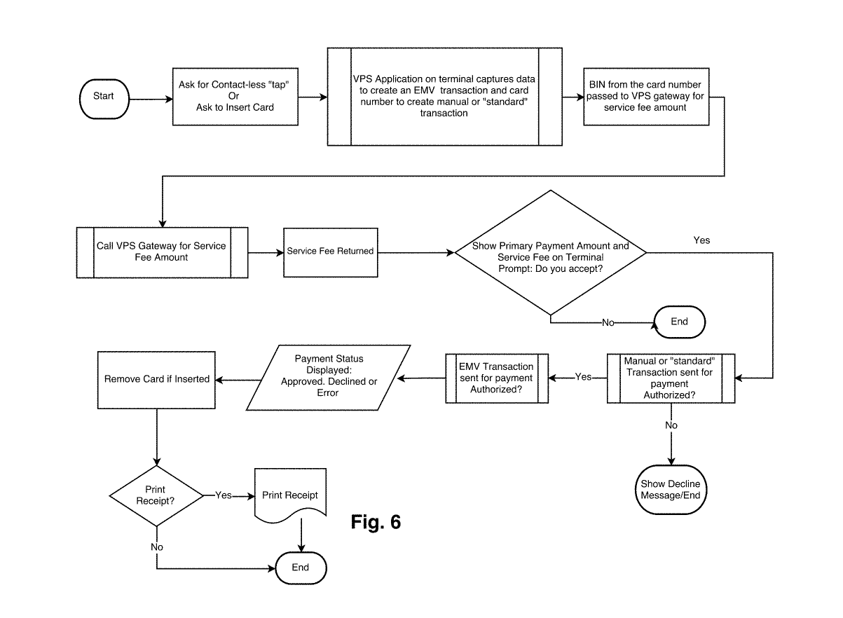

FIG. 6 illustrates a method for processing an EMV transaction which includes payments to multiple payees with only one insertion or tap. A terminal prompts for insertion of a smart chip card or a tap or placement of a smart chip card within a predetermined proximity of the terminal. An application on the terminal captures data from the card to create a smart chip or EMV transaction and a manual or standard transaction. The data captured by the application on the terminal includes, inter alia, an ARQC and Tag 57 Track 2 Equivalent Data including the card number. The Bank Identification Number (BIN) is sent to a payment processing gateway associated with the application on the terminal to determine a convenience fee or service fee amount. Upon determining the convenience fee or service fee, a total transaction amount is displayed on the terminal. Preferably, the total transaction amount is displayed as an itemized amount. Upon receiving acceptance of the total transaction amount, the manual or standard transaction is authenticated using the card number through the payment processing gateway. Preferably, the manual or standard transaction is a transaction for the convenience fee or service fee. Once the manual or standard transaction has been authenticated and processed, the EMV or smart chip payment is authorized and processed through the payment processing gateway. The terminal displays the results of the transaction and prompts for removal of the EMV or smart chip card if inserted. The terminal then optionally queries as to whether a receipt for the transaction should be printed.

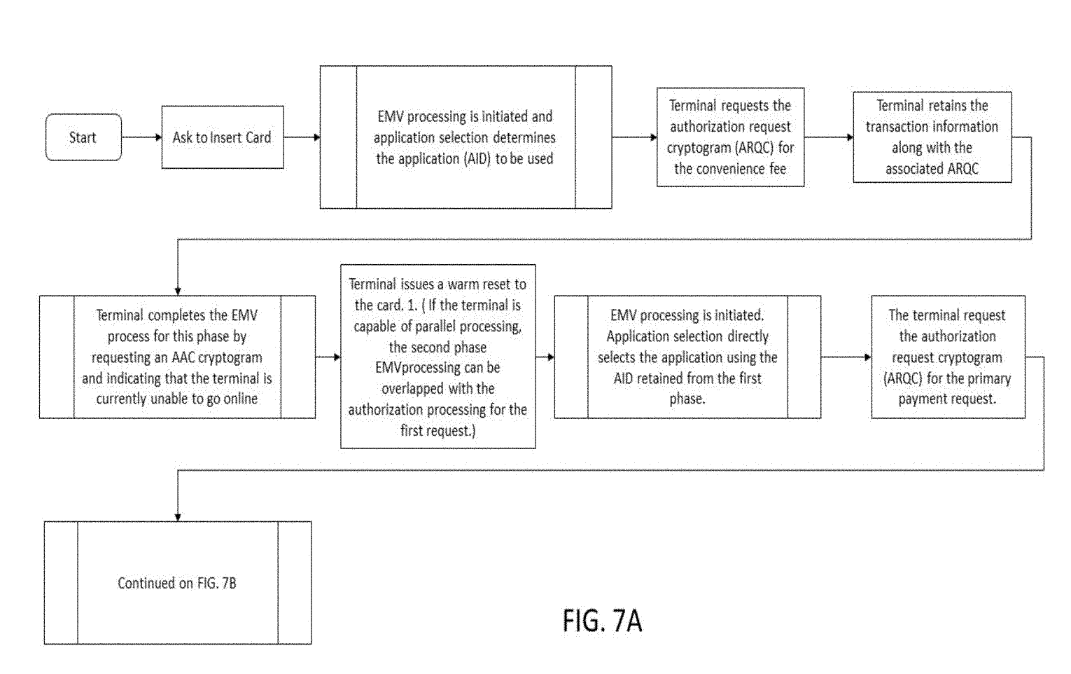

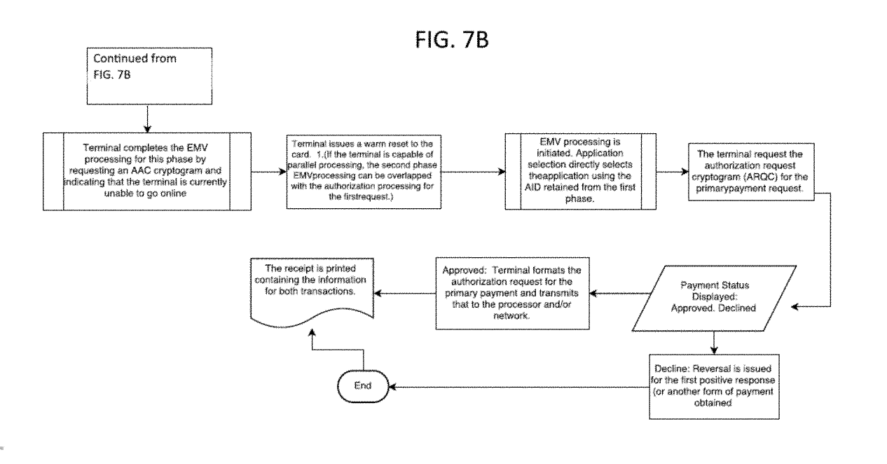

FIGS. 7A & 7B illustrate a method for processing two separate payments to two different entities with a single dip or tap of a smart chip card including the following steps. FIG. 7A includes the steps of a terminal prompting for insertion of a smart chip card and initiating EMV processing and application selection to determine the application ID (AID) to be used for the transaction. Upon determining the AID, the terminal requests the ARQC for the first payment, which is a convenience fee in FIG. 7A. The terminal retains the transaction information along with the associated ARQC and completes the EMV processing for this phase by requesting an AAC and indicating that the terminal is currently unable to go online. The terminal issues a warm reset to the card. Notably, if the terminal is capable of parallel processing, the second phase EMV processing can be overlapped with the authorization processing for the first request. EMV processing is initiated for the second phase or payment with the application selection directly selecting the application using the AID retained from the first phase. The terminal then requests the ARQC for the second payment, which in FIG. 7A is a primary payment.

In FIG. 7B, the terminal completes the EMV processing for the second phase by requesting an AAC and indicating that the terminal is currently unable to go online. The terminal then issues a warm reset o the card. EMV processing is initiated and the application selection directly selects the application using the AID retained from the first phase. The terminal requests the ARQC for the primary payment request and a payment status (approved or declined) is displayed. If the payment status is declined, a reversal is issued for the first payment or another form of payment is obtained for the second payment. If the payment is approved, the terminal formats the authorization request for the primary payment and transmits that to the processor and/or network. The receipt is then printed containing the information for both transactions.

In yet another embodiment, a method for processing two separate payments to two different entities with a single dip or tap of a smart chip card. A smart chip terminal displays a prompt for insertion of a smart chip card into the terminal or placement of the smart chip card within a predetermined proximity of the terminal for contactless payment, preferably via Radio Frequency (RF) technology, including by way of example Near Field Communication (NFC). The terminal preferably displays a total transaction amount for the payments to multiple payees included in the transaction. The card reader initiates smart chip processing by selecting a payment application via an application ID (AID) on the smart chip card to be used for the transaction. Application selection for the smart chip card is performed via an application on the terminal or via an EMV application kernel or a smart chip application kernel. The terminal requests an authorization request cryptogram (ARQC) from the smart chip card for a first payment to a first payee. Upon receiving the ARQC, the terminal formats an authorization request for the first payment to the first payee in the transaction and transmits the authorization request to the payment processing gateway or network. Notably, the payment processing gateway or network processes the payment as a non-smart chip or non-EMV transaction in determining whether the first payment is authorized. Upon receiving a positive authorization response from the payment processing gateway or network, the terminal requests a first transaction certificate from the smart chip card to complete the smart chip processing for the payment to the first payee. The terminal issues a warm reset to the smart chip card after receiving the transaction certificate. In one embodiment, the warm reset is preferably performed by sending a signal through a Voltage Source-Source (Vss) pin or ground (GND) pin to reset the card without disconnecting or interrupting power supply to the terminal.

After performing a warm reset on the card, the terminal initiates smart chip processing for the second payment to the second payee. The terminal automatically selects the payment application utilized for the first payment to the first payee using the AID, which the terminal has retained after the first payment to the first payee. The terminal requests an ARQC for the second payment, and upon receiving the ARQC, the terminal formats the authorization request for the second payment and transmits the authorization request to the payment processing gateway or network. Upon receipt of a positive authorization response from the payment processing gateway or network, the terminal requests a second transaction certificate from the smart chip card to complete the smart chip processing for the second payment. If a decline is received for the second payment request, the terminal preferably issues a reversal or voiding for the first payment or first authorization. Alternatively, an alternative form of payment is obtained for the second payment, with the terminal requesting an ARQC for the alternative form of payment and formatting and transmitting the authorization request to the gateway or network upon receiving the ARQC for the alternative form of payment. Upon accepting or declining the payment from the smart chip card for the first payment and/or the second payment, the terminal displays the outcome of the first payment and the second payment. Preferably, if an acceptance message is displayed, the terminal does not itemize the acceptance of the first payment and the second payment but instead displays an acceptance message for the total transaction amount. Similarly, if one or both payments are declined, a message which states that the payment was declined is displayed. After or concurrent with displaying the message which states the outcome of the transaction, the terminal displays a prompt to remove the smart chip card if the transaction is a contact EMV or smart chip transaction. In one embodiment, a receipt is printed for the transaction which includes itemized information for the first payment and the second payment.

Another exemplary embodiment of the present invention is a method for processing two smart chip transactions with a single dip or tap using a quick chip smart chip card, with the method including the following steps. A smart chip terminal displays a prompt for insertion of a smart chip card into the terminal or placement of a contactless smart chip card within a predetermined proximity of the terminal. The card reader initiates smart chip processing by selecting a payment application via an AID on the smart chip card to be used for the transaction. Application selection is performed via an application on the terminal or via an EMV application kernel or smart chip application kernel. The terminal requests an ARQC from the smart chip card for a first payment to a first payee. Upon receiving the ARQC, the terminal retains the transaction information along with the associated ARQC. The terminal requests an application authorization cryptogram (AAC) from the smart chip card and indicates to the EMV application kernel that the terminal is currently unable to go online. The terminal issues a warm reset to the smart chip card and initiates smart chip processing for a second payment to a second payee. In one embodiment, the terminal automatically selects the payment application selected for the first payment to the first payee. Application selection is preferably performed using the AID retained from the first payment to the first payee. The terminal then requests a ARQC for a second payment to a second payee, retaining transaction information along with the associated ARQC. The terminal requests an AAC from the smart chip card for the second payment, indicating to the EMV application kernel that the terminal is currently unable to go online. Notably, for terminals which are capable of parallel processing, the second smart chip payment to the second payee is processed simultaneously with the first payment to the first payee. The terminal displays a prompt instructing removal of the smart chip card if the transaction is a contact EMV or smart chip transaction. If the transaction is a contact smart chip transaction, upon removal of the smart chip card, the terminal sends the ARQC, AAC, and/or an authorization request for the first payment to the first payee to the gateway or network. If sent to the gateway, the gateway formats the ARQC or AAC into an authorization request and sends the authorization request to the payment processing network. Upon receiving a positive response from the gateway or network for the first authorization request, the terminal formats an authorization request for the second payment to the second payee and transmits the authorization request to the gateway or network. Either a positive response or a decline is received. If a decline is received for the second request, the terminal issues a reversal for the first positive response. Alternatively, another form of payment is obtained for the second payment to the second payee. The terminal displays the outcome of the first payment and the second payment. In one embodiment, a receipt is printed for the transaction including information for the first payment and the second payment.

In one embodiment, the first payment to the first party is a principal payment and the second payment to the second party is a convenience fee or surcharge related to the first payment. The first party is, by way of example and not limitation, a government entity such as a federal government, a state government, a city or municipality government, a government office such as a Department of Motor Vehicles, etc. The second party is, by way of example and not limitation, a payment processing gateway, a processor, or an intermediary for the transaction.

Notably, the present invention is inextricably tied to computer technology. The present invention requires a smart chip terminal for reading a smart chip of a smart chip card and for communicating with the payment processing gateway or payment processor to authorize the transaction. The present invention is not merely linking an abstract idea to a technological environment. Rather, the improvements of the present invention to the prior art solve the problem of a payor being required to insert his or her card multiple times or place his or her card multiple times within a predetermined proximity of the terminal for multiple payments to multiple payees. This is a problem which arises specifically in the realm of smart chip card payments to multiple payees, particularly when a convenience fee or surcharge is paid to a different party than the recipient of a principal payment. The present invention solves this problem using the technological solutions described above. By way of example, one technological solution of the present invention includes a terminal issuing a warm reset to a smart chip card, preferably by sending a signal through a Vss/GND pin to reset the card, after receiving a transaction certificate for a first payment to a first payee in a transaction with multiple payments to multiple payees. After issuing the warm reset to the card, the terminal initiates smart chip processing for the second payment to the second payee using the AID from the first payment to the first payee. This solves the computer and technology specific problem of a smart chip card user being required to insert their card multiple times or place their card within a predetermined proximity of a terminal multiple times for a transaction with multiple payments, namely a transaction with a surcharge or a convenience fee.

Additionally, the present invention represents an improvement to computer technology. The present invention provides faster processing speeds for smart chip terminals in processing smart chip transactions than the prior art by processing multiple payments to multiple payees during a single insertion of the smart chip card or single tap of a contactless smart chip card as described in the embodiments above. The systems and methods for processing these transactions also uses less memory than traditional smart chip terminal methods for processing multiple payments to multiple payees. Faster processing speeds and reduced memory usage provides for an improved ability of the computer to interact with the user. Furthermore, the present invention causes the smart chip terminal to operate in an unconventional manner to deliver these benefits and improvements in computer functionality. The present invention not only improves computer technology, but also improves the technology of smart chip terminal processing as it used to process multiple payments to multiple payees in a single smart chip transaction. Specifically, the combination of steps improves the processing speed of smart chip transactions with payments to multiple payees.

The present invention is also a technology-based solution which overcomes the disadvantages of the prior art by providing for processing multiple payments in one dip or tap of a smart chip card. In the prior art, smart chip transactions which include payments to multiple payees have traditionally required a dip of the smart chip card into the terminal or tap of the smart chip card within a predetermined proximity of the terminal for each payment. The present invention solves this unique problem associated with smart chip transactions. In one embodiment, the present invention solves this unique problem by issuing a warm reset to a smart chip card, preferably by sending a signal through a Vss/GND pin to reset the card, after receiving a transaction certificate for a first payment to a first payee in a transaction with multiple payments to multiple payees. After issuing the warm reset to the card, the terminal initiates smart chip processing for the second payment to the second payee using the AID from the first payment to the first payee and requesting an ARQC for the second payment. These unconventional steps provide a technological solution to a unique problem with prior art smart chip transactions which involving payments to multiple payees.

Additionally, the present invention enables the smart chip terminal, which is a specialized and particular computing device, to process payments to multiple payees in one smart chip card transaction. The programming of the smart chip terminal acts in concert with the hardware and software features of the smart chip terminal to enable the smart chip terminal to process these transactions as described herein. The usefulness of smart chip payment card processing is extended into applications of processing more than one payment to multiple payees with a single insertion or single tap. When viewed as a combination, these features amount to an inventive concept and significantly more than any judicial exception or abstract idea present in the invention.

The present invention also addresses a longstanding, unmet need in EMV or smart chip transactions. Convenience fees have existed at least since the implementation of card transactions, and EMV standards have existed since 1994. No solution described in any publication or on the market today provides for processing payments to multiple payees with a single EMV or smart chip transaction. The present invention meets this longstanding and unmet need by providing for multiple payments to multiple payees to be performed with a single dip of an EMV or smart chip card into a payment terminal or single tap of a smart chip card within a predetermined proximity of the payment terminal.

In one embodiment, the smart chip terminal of the present invention is a terminal with an ARM 9 & ARM 7 processor providing 450 MIPS & 50 MIPS with 32 RAM of memory and 128 Flash. The terminal is connected over ethernet or through a dial-up modem to a payment processing gateway or a payment processing network. Preferably, the terminal includes an RS232 connection, a USB host connection, a USB slave connection, and a power supply connector. The terminal is an Ingenico ICT220 device in one embodiment.

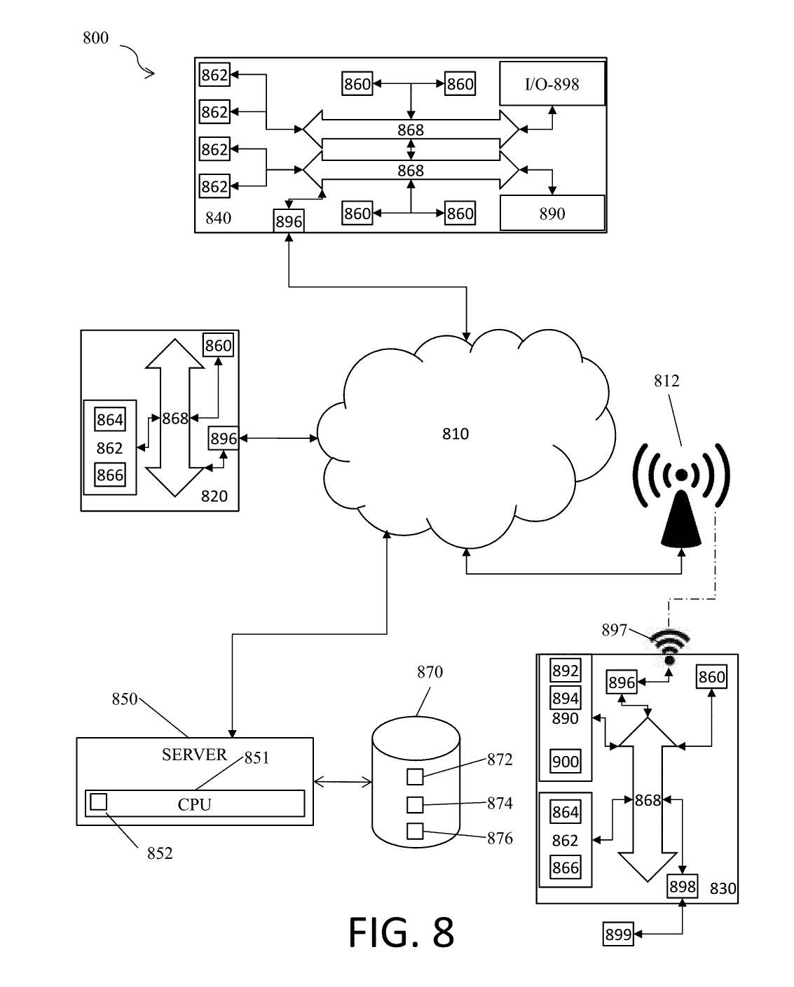

FIG. 8 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 may house an operating system 872, memory 874, and programs 876.

In one embodiment of the invention, the system 800 includes a cloud-based network 810 for distributed communication via a wireless communication antenna 812 and processing by at least one mobile communication computing device 830. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 8, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to a bus 868. Computing devices may communicate communication media through wired networks, direct-wired connections or wirelessly, such as acoustic, RF, or infrared, through an antenna 897 in communication with the network antenna 812 and the network interface unit 896 , which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

It is also contemplated that the computer system 800 may not include all of the components shown in FIG. 8, may include other components that are not explicitly shown in FIG. 8, or may utilize an architecture completely different than that shown in FIG. 8. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By way of example, the handle may pivot in multiple axes. Also by way of example, the limbs may be solid. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A method for processing multiple payments in a single smart chip card transaction at a smart chip terminal comprising:
a smart chip terminal establishing communication with a smart chip card;
the smart chip terminal determining an application kernel on the smart chip card to use for the multiple payments;
the smart chip terminal extracting a primary account number for the smart chip card;
the smart chip terminal transmitting a first authorization request for a first payment including the primary account number to a payment processing gateway;
the payment processing gateway processing the first authorization request as an authorization request for a non-smart chip transaction;
upon receiving a positive authorization response from the payment processing gateway for the first authorization request, the smart chip terminal requesting a first transaction certificate from the smart chip card to complete processing of the first payment;
the smart chip terminal transmitting a second authorization request for a second payment to the payment processing gateway; and
upon receiving a positive authorization response from the payment processing gateway for the second authorization request, the smart chip terminal requesting a second transaction certificate from the smart chip card to complete processing of the second payment.

2. The method of claim 1, wherein the primary account number is obtained via track 2 tag 57 data retrieved for the application kernel.

3. The method of claim 1, further comprising the smart chip terminal issuing a warm reset to the smart chip card upon receiving the first transaction certificate.

4. The method of claim 1, further comprising:
the smart chip terminal extracting a Bank Identification Number (BIN) before extracting the primary account number;
sending the BIN to the payment processing gateway;
the payment processing gateway calculating an amount of the first payment based on the BIN in real-time;
the payment processing gateway transmitting the amount of the first payment to the smart chip terminal;
the smart chip terminal displaying a total amount for the multiple payments including the amount of the first payment and the amount of the second payment; and
upon the smart chip terminal receiving acceptance of the total amount for the multiple payments, the smart chip terminal extracting the primary account number for the smart chip card.

5. The method of claim 1, further comprising the smart chip terminal extracting an authorization request cryptogram (ARQC) from the smart chip card, wherein the first authorization request for the first payment includes the primary account number and the second authorization request for the second payment includes the ARQC.

6. The method of claim 1, wherein the second authorization request for the second payment does not include the primary account number.

7. A method for processing multiple payments in a single smart chip card transaction at a smart chip terminal comprising:
a smart chip terminal establishing communication with a smart chip card;
the smart chip terminal determining an application kernel on the smart chip card to use for the multiple payments;
the smart chip terminal extracting a primary account number for the smart chip card;
the smart chip terminal requesting an application authorization cryptogram (AAC) the smart chip card for a first payment;
the smart chip terminal indicating that the smart chip terminal is currently unable to go online for the first payment;
the smart chip terminal requesting the AAC from the smart chip card for a second payment;
the smart chip terminal indicating that the smart chip terminal is currently unable to go online for the second payment;
breaking the communication between the smart chip terminal and the smart chip card so that the smart chip terminal and the smart chip card are no longer in communication;
upon breaking the communication between the smart chip terminal and the smart chip card:
the smart chip terminal transmitting a first authorization request including the primary account number to a payment processing gateway;
the payment processing gateway processing the first authorization request as an authorization request for a non-smart chip transaction;
upon receiving a positive authorization response from the payment processing gateway for the first authorization request, the smart chip terminal transmitting a second authorization request to the payment processing gateway; and
upon receiving a positive authorization response from the payment processing gateway for the second authorization request, the smart chip terminal completing processing of the second payment.

8. The method of claim 7, wherein the primary account number is obtained via track 2 tag 57 data retrieved for the application kernel.

9. The method of claim 7, further comprising the smart chip terminal issuing a warm reset to the smart chip card upon receiving the AAC from the smart chip card for the first payment.

10. The method of claim 7, further comprising:
the smart chip terminal extracting a Bank Identification Number (BIN) before extracting the primary account number;
sending the BIN to the payment processing gateway;
the payment processing gateway calculating an amount of the first payment based on the BIN in real-time;
the payment processing gateway transmitting the amount of the first payment to the smart chip terminal;
the smart chip terminal displaying a total amount for the multiple payments including the amount of the first payment and the amount of the second payment; and
upon the smart chip terminal receiving acceptance of the total amount for the multiple payments, the smart chip terminal extracting the primary account number for the smart chip card.

11. The method of claim 7, further comprising the smart chip terminal extracting an authorization request cryptogram (ARQC) from the smart chip card, wherein the first authorization request for the first payment includes the primary account number and the second authorization request for the second payment includes the ARQC.

12. The method of claim 7, wherein the second authorization request for the second payment does not include the primary account number.

13. A system for processing multiple payments in a single smart chip card transaction at a smart chip terminal comprising:
a smart chip card including a smart chip;
a smart chip terminal operable to establish communication with the smart chip card; and
a payment processing gateway comprising at least one remote server computer with a processor connected to the smart chip terminal for processing multiple payments initiated with the smart chip card;
wherein the smart chip terminal is operable to send a first authorization request formatted as a non-smart chip transaction authorization request to the payment processing gateway for a first payment in the single smart chip transaction;
wherein the smart chip terminal is operable to send a second authorization request to the payment processing gateway for a second payment in the single smart chip transaction;
wherein upon receiving approval of the first authorization request and the second authorization request, the smart chip terminal is operable to complete processing for the single smart chip transaction.

14. The system of claim 13, wherein the smart chip terminal is operable to extract a primary account number of the smart chip card, wherein the first authorization request includes the primary account number of the smart chip card.

15. The system of claim 13, wherein the smart chip terminal is operable to issue a warm reset to the smart chip card upon receiving a first transaction certificate from the smart chip card.

16. The system of claim 13, wherein the smart chip terminal is operable to issue a warm reset to the smart chip card upon receiving an application authorization cryptogram (AAC) from the smart chip card for the first payment.

17. The system of claim 14, wherein the smart chip terminal is operable to extract a Bank Identification Number (BIN) before extracting the primary account number and is further operable to send the BIN to the payment processing gateway;
wherein the payment processing gateway is operable to:
calculate an amount of the first payment based on the BIN in real-time and transmit the amount of the first payment to the smart chip terminal;
the smart chip terminal being further operable to display a total amount for the multiple payments including the amount of the first payment and upon the smart chip terminal receiving acceptance of the total amount for the multiple payments, the smart chip terminal being operable to extract the primary account number for the smart chip card.

18. The system of claim 13, further comprising the smart chip terminal extracting an authorization request cryptogram (ARQC) from the smart chip card, wherein the first authorization request for the first payment and the second authorization request for the second payment include the ARQC.

19. The system of claim 14, wherein the second authorization request for the second payment does not include the primary account number.

20. The system of claim 13, wherein the smart chip terminal is operable to send the first authorization request and the second authorization request to the payment processing gateway after the smart chip card and the smart chip terminal are no longer in communication.
